(19) United States
(12) Patent Application Publication
(10) Pub. No.: US 2022/0298600 A1
(43) Pub. Date: Sep. 22, 2022

(54) METHOD FOR PROCESSING ORE OR REFINING INTERMEDIATE

(71) Applicant: JX NIPPON MINING & METALS CORPORATION, Tokyo (JP)

(72) Inventors: Yuken FUKANO, Hitachi-shi (JP); Shigetaka UENISHI, Kitaibaraki-shi (JP); Kodai MANO, Hitachi-shi (JP)

(73) Assignee: JX NIPPON MINING & METALS CORPORATION, Tokyo (JP)

(21) Appl. No.: 17/637,387

(22) PCT Filed: Sep. 30, 2020
(86) PCT No.: PCT/JP2020/037292

§ 371 Date: Feb. 22, 2022

(30) Foreign Application Priority Data
Oct. 31, 2019 (JP) 2019-199328

(51) Int. Cl. C22B 3/08; C22B 3/24; C22B 11/00; B01J 20/20; B01J 20/34; C22B 15/00

(52) U.S. Cl. CPC C22B 3/08; C22B 3/24; C22B 11/04; B01J 20/20; B01J 20/34; C22B 15/0086; C22B 15/0071

(57) ABSTRACT

A method for processing ores containing gold or refining intermediates containing gold, the refining intermediate being obtained by subjecting the ores to a refining process, wherein the method includes: a leaching step of leaching gold from the ores or the refining intermediates using a sulfate solution containing iodide ions and iron (III) ions as a leaching solution; an adsorption step of adsorbing iodine and gold in the leached solution obtained in the leaching step on activated carbon; and an iodine separation step of separating iodine from the activated carbon while leaving gold on the activated carbon that has undergone the adsorption step.

### FIELD OF THE INVENTION

The present disclosure relates to a method for processing ores or refining intermediates containing gold.

### BACKGROUND OF THE INVENTION

For example, a hydrometallurgical process is known as a technique for recovering gold contained in ores such as chalcopyrite and other sulfide minerals and silicate ores, and gold contained in refining intermediates which are leached residues obtained by leaching copper in copper sulfide ores or iron in iron pyrites.

The mainstream of this type of hydrometallurgical process is a so-called cyanide process, which forms a complex with the gold in the ores or refining intermediates to leach it in a cyanide solution as a leaching solution. Relevant arts include those described in Non-Patent Literatures 1 to 5.

For the ores or the like having lower gold content, the cyanide process may employ heap leaching in which a leaching solution is fed to a group of ores deposited in the open air by spraying or the like, and a leached solution that drips from a lower side through the group of ores is recovered.

Patent Literature 1 also discloses a technique for leaching gold contained in ores using a leaching solution to which iodine has been added. The iodine in the leaching solution forms a complex with the gold, which improves the reactivity of the gold with the leaching solution, thus enabling efficient leaching of the gold.

### CITATION LIST

### Patent Literatures

[Patent Literature 1] U.S. Pat. No. 4,557,759

### Non-Patent Literature

[Non-Patent Literature 1] S.S.KONYRATBEKOVA et al., “Thermodynamic and kinetic of iodine-iodide leaching in gold hydrometallurgy”, Transactions of Nonferrous Metals Society of China, Volume 25, November 2015, p. 3774-3783
[Non-Patent Literature 2] FRICKER A G., “Recovery of cyanide in the extraction of gold”, Journal of Cleaner Production, Volume 1, 1993, p. 77-80
[Non-Patent Literature 3] TRAPP S et al., “Feasibility of cyanide elimination using plants”, The European Journal of Mineral Processing and Environmental Protection, Volume 3, No.1, 1303-0868, 2003, p. 128-137
[Non-Patent Literature 4] MUDDER T I et al., “Cyanide and society: a critical review”, The European Journal of Mineral Processing and Environmental Protection, Volume 4, No. 1, 1303-0868, 2004, p. 62-74
[Non-Patent Literature 5] BOTZ M et al., “Cyanide Treatment: Physical, Chemical, and Biological Processes”, Gold Ore Processing (Second Edition), Project Development and Operations, 2016, p. 619-645

### SUMMARY OF THE INVENTION

### Technical Problem

However, since the use of cyanide in the cyanide process is often restricted due to its toxicity, the use of such a chemical is not desirable. Especially in heap leaching, cyanide is used in an open environment, so that there is concern about its environmental impact.

If the ores contain copper in addition to gold, it is difficult to effectively leach the gold from the ores with the cyanide solution because the cyanide is consumed by the copper in the ores.

In addition, the ores containing gold and copper are generally recovered as gold/copper refined ores by ore flotation, and the refined ores are recovered as gold/copper ores in a smelter by pyrometallurgy or the like. However, if the gold/copper refined ores have a lower metal grade or contain relatively high levels of impurities such as arsenic and mercury which are problematic in pyrometallurgy, the gold/copper refined ores cannot be processed in the smelter for reasons such as increased processing costs and other economic reasons.

In addition to the cyanide process, an approach of leaching gold using chlorine or bromine which has lower environmental impact, has been studied. However, this approach has not yet been put to practical use due to a leaching rate and costs.

In the technique described in Patent Literature 1, gold is recovered by passing the leaching solution through activated carbon and adsorbing the gold into the micropores of the activated carbon. However, there are various substances other than gold in the leaching solution. There is a possibility that these substances, in addition to the gold, may be adsorbed into the micropores of the activated carbon, but the possibility is not considered in Patent Literature. In particular, iodine forms a complex with gold, and it is essential to consider the behavior of iodine existing in this state for the activated carbon.

In general, the leaching solution is repeatedly used. Therefore, if iodine is adsorbed on the activated carbon, the adsorbed iodine must be desorbed from the activated carbon in some way. Furthermore, in the desorbing process, it is not sufficient to simply desorb iodine from the activated carbon, but it is necessary to selectively desorb gold and iodine, which requires various studies.

As a result of intensive studies, the present inventors have solved the above problems. The present inventors have created a method for processing ores or refining intermediates, which can effectively extract gold from ores or refining intermediates containing gold. The processing method is disclosed in this specification.

### Solution to Problem

A method for processing ores or refining intermediates disclosed herein is directed to a method for processing ores containing gold or refining intermediates containing gold, the refining intermediates being obtained by subjecting the ores to a refining process, wherein the method comprises: a leaching step of leaching gold from the ores or the refining intermediates using a sulfate solution containing iodide ions and iron (III) ions as a leaching solution; an adsorption step of adsorbing iodine and gold in the leached solution obtained in the leaching step on activated carbon; and an iodine separation step of separating iodine from the activated carbon while leaving gold on the activated carbon that has undergone the adsorption step.

### Advantageous Effects of Invention

According to the method for processing ores or refining intermediates as described above, it is possible to effectively extract gold from ores or refining intermediates that contain gold.

### BRIEF DESCRIPTION OF THE DRAWINGS

FIG. 1 is a flow chart showing a method for processing ores or refining intermediates according to an embodiment;

FIG. 2 is a graph showing an adsorption rate and a desorption rate of iodine in Test 2 of Example; and

FIG. 3 is a graph showing an adsorption rate and a desorption rate of gold in Test 2 of Example.

### DETAILED DESCRIPTION OF THE INVENTION

Hereinafter, embodiments disclosed in this specification will be described. A method for processing ores or refining intermediates according to an embodiment is to process such ores or refining intermediates, in order to recover gold from ores containing gold, or refining intermediates containing gold, which are obtained by subjecting the ores to a refining process. More particulary, the processing method includes: a leaching step of leaching gold from the ores or the refining intermediate using a sulfate solution containing iodide ions and iron (III) ions as a leaching solution; an adsorption step of adsorbing iodine and gold in the leached solution obtained in the leaching step on activated carbon; and an iodine separation step of separating iodine from the activated carbon while leaving gold on the activated carbon that has undergone the adsorption step.

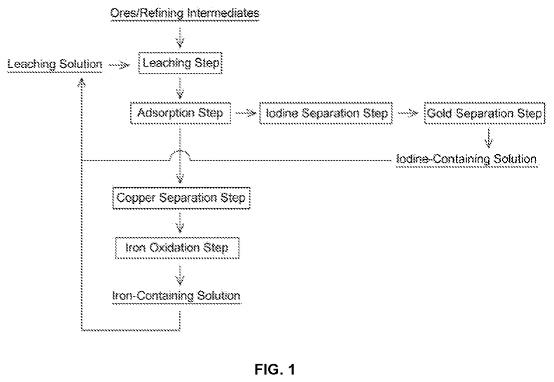

Typically, the ores or refining intermediates contain not only gold but also copper, and the method for processing such ores or refining intermediates may include each of the steps as shown in FIG. 1. This embodiment may also be applied to ores or refining intermediates that do not contain copper, optionally by modify the embodiment.

### (Ores or Refining Intermediate)

The ores and refining intermediates may be, for example, ores containing at least one selected from chalcocite, bornite, covelline, copper pyrite, iron pyrite, enargite, arsenopyrite, galena, sphalerite, arsenical pyrite, antimonite, and magnetic pyrite, or ores containing gold and sulfur such as silicate ores, or intermediates obtained after refining the ores (also referred herein to as “refining intermediates”).

As used herein, the refining process refers to, for example, a process of leaching copper with a certain leaching solution for copper ores, or a process of leaching iron with a certain leaching solution for iron ores. Leached residues obtained from such a process can be used as refining intermediates.

The ore and refining intermediates may be refined ores after conventional ore dressing processes such as flotation and specific gravity sorting, if necessary. The ores can also be crushed and ground to reduce the particle size of the ores so that the leaching solution in the leaching step and the like can easily be brought into contact with the gold inside the ores.

It is to understood that the ores or refining intermediates contain gold, and the gold content is typically from about 0.1 ppm by mass to about 500 ppm by mass, and more typically from about 0.5 ppm by mass to about 50 ppm by mass.

The ores or refining intermediates may also contain copper. In this case, the copper content in the ores or refining intermediates is, for example, from 0.1% to 10% by mass, and typically from 0.2% to 5% by mass.

### (Leaching Step)

In the leaching step, a sulfate solution containing iodide ions and iron (III) ions is used as a leaching solution, and the leaching solution is brought into contact with the ores or refining intermediates to leach gold from the ores or the refining intermediates. The leaching solution containing iodide ions can effectively promote the leaching of gold. Here, it is presumed that gold forms a complex with iodine ([AuI₂]⁻, [AuI₄]⁻, or the like), and dissolves, and it is believed that the leaching proceeds by the reaction with iodine, based on the following formula (1) or (2):

2Au+I₃⁻+I⁻→2[AuI₂]⁻ (1)

2Au+3I₃⁻→2[AuI₄]⁻+I⁻ (2)

If the ores or refining intermediates also contain copper, the copper is leached out together with the gold in the leaching step. For example, the dissolution or leaching of copper sulfide ores may proceed by a series of catalytic reactions with iodine as shown in formulae (2-1) and (2-2) below. When taking both sides of the formulae (2-1) and (2-2) and eliminating the iodine component, the following formula (2-3) is obtained. It is understood that this is a leaching reaction of copper sulfide ores with iron(III) ions as an oxidizing agent.

2I⁻+2Fe³⁺→I₂+2Fe²⁺ (2-1)

CuFeS₂+I₂+2Fe³⁺→Cu²⁺+3Fe²⁺+2S°2I⁻ (2-2)

CuFeS₂+4Fe₃+→Cu²⁺+5Fe²⁺+2S (2-3)

The leaching of gold and copper herein is carried out by reaction with a leaching solution containing iodine (I₂), but iodine has lower solubility in water. Therefore, to the leaching solution is preferably added an iodide which is easily dissolved in the leaching solution and dissociated into iodide ions (I⁻). Such an iodide is preferably dissolved in water to generate iodide ions, and specific examples of the iodide that can be used herein include sodium iodide, potassium iodide, ammonium iodide, and hydrogen iodide. As described below, it is also possible to add to the leaching solution in the leaching step an iodine-containing solution containing iodine in the above various forms or other forms obtained by separating the iodine adsorbed on the activated carbon in the leached solution in the adsorption step from the activated carbon in the iodine separation step.

The leaching solution contains iodide ions (I⁻). The leaching solution may also contain triiodide ions (I₃⁻) which are produced by reaction of elemental iodine (I₂) with iodide ions (I), the elemental iodine being generated by the reaction of the above formula (1).

The iodine concentration in the leaching solution including such iodide ions (I) and triiodide ions (I₃⁻) is preferably from 10 mg/L to 10000 mg/L, and more preferably from 50 mg/L to 1000 mg/L. If the iodine concentration is too low, there is a concern that leaching rates of gold and copper cannot be sufficiently increased. On the other hand, if the iodine concentration is too high, there is a risk of deterioration of economic efficiency due to iodine loss.

Further, as can be seen from the above formulae, the leaching solution requires iron (III) ions as an oxidizing agent, and supplement of iron (III) ions in order to continue the leaching.

The iron (III) ion concentration in the leaching solution is preferably from 1000 mg/L to 20000 mg/L, and more preferably from 2000 mg/L to 10000 mg/L. It is preferable that the iron (III) ion concentration in the leaching solution is 20 times or more the iodine concentration in weight ratio (the iodine concentration is 100 mg/L, whereas the iron (III) ion concentration is 2 g/L or more).

Non-limiting examples of sources of the iron (III) ions include iron (III) sulfate, iron (III) chloride, or those obtained by oxidizing iron (II) ions in an iron (II) sulfate solution. Further, as will be described later, the iron-containing solution obtained by subjecting the leached solution to the adsorption step, the copper separation step and the iron oxidation step can be added to the leached solution and reused. The iron (III) ions are converted into iron (II) ions by the reaction described above.

The pH of the leaching solution can be adjusted to 2.5 or less with sulfuric acid or the like in order to prevent the precipitation of iron (III) ions.

The leaching step described above can be carried out in any manner of leaching, and for example, it can be batch stirring leaching, or it can be heap leaching or dump leaching in which the leaching solution is sprayed on a group of deposited ores. Alternatively, it can also employ in-place leaching in which the leaching solution is poured into underground ore bodies.

The leaching can be carried out at any temperature, even at ordinary temperature without heating.

The leached solution obtained by subjecting the ores or refining objects to the above leaching step has a gold concentration of, for example, from 0.1 mg/L to 100 mg/L, and a copper concentration of, for example, from 100 mg/L to 10000 mg/L.

### (Adsorption Step)

In the adsorption step, iodine and gold in the leached solution are adsorbed on activated carbon. The activated carbon may be common activated carbon generally used as an adsorbent for adsorbing gold, for example, general activated carbon produced by a physical process such as an activation process to change wood, coconut shells or other carbonaceous materials into porous materials, or a chemical process using chemicals. The activated carbon preferably has a large surface area, is suitable for use in the liquid phase, and has good stability, as well as is in particulate or spherical form. Specific examples include Yashicor Mc (Activated Carbon (Coconut Shell) from Taihei Chemical Industry, Co., Ltd.; SHIRASAGI X7000 H from OSAKA GAS CHEMICALS CO., LTD; and the like.

The use of the activated carbon for the leached solution allows gold to be adsorbed on the activated carbon together with iodine in the leached solution. The adsorbed solution obtained after adsorbing iodine and gold in the leached solution on the activated carbon in the adsorption step preferably has an iodine concentration of 10 mg/L or less and a gold concentration of 1 mg/L or less. On the other hand, since the copper in the leached solution is not adsorbed on the activated carbon, it remains in the adsorbed solution.

By adsorbing iodine on the activated carbon in the adsorption step and removing the iodine from the adsorbed solution, iodine loss can be prevented in the subsequent copper separation step and iron oxidation step, which are carried out for the adsorbed solution, and a decrease in an iron oxidation rate can be suppressed.

### (Iodine Separation Step)

The activated carbon on which iodine and gold have been adsorbed in the adsorption step can be subjected to the iodine separation step. In the iodine separation step, iodine is separated from the activated carbon while leaving the gold on the activated carbon.

It is known that iodine can be separated from the activated carbon on which iodine is adsorbed using a predetermined desorption solution. However, in the case of the activated carbon that has adsorbed not only iodine but also gold, an impact of the gold on the separation of iodine from the activated carbon is not known.

However, the test results described in Examples below provide a novel finding that only iodine can be substantially separated from the activated carbon on which iodine and gold are adsorbed. Therefore, it is believed that the above leaching using iodine can be effectively applied to the recovery of gold from the ores or refining intermediates that contain gold. Further, if the ores or the refining intermediates contain gold and copper, this embodiment can be applied to recover gold and copper at the same time, thereby achieving an improved economic efficiency.

The iodine in the gold iodide that forms a complex with gold and is adsorbed on the activated carbon may not be separated from the activated carbon in the iodine separation step, and may remain on the activated carbon together with the gold. However, the loss of iodine herein is not problematic so much, because, in most cases, the ores or refining intermediates that contain a small amount of gold as mentioned above are targeted. Further, a large amount of iodine lost means a large amount of gold complexed with iodine, attached to the activated carbon, resulting in a higher gold recovery rate.

In the iodine separation step, a sulfurous acid solution, iron (II) ions, or hydrazine may be used as a desorption solution for contacting it with the activated carbon to separate iodine from the activated carbon. In particular, the sulfurous acid solution is preferable because the solution itself is oxidized by the reaction to form sulfuric acid, which will not be an impurity when the leaching solution is repeatedly used. When using the sulfurous acid solution as the desorption solution, an amount of sulfurous acid is not particularly limited, but typically the iodide ions can be recovered using a solution containing an amount of sulfurous acid ion that is 0.1 to 10 times an amount of iodide ions to be eluted, in weight ratio. The concentration of sulfite ions in the sulfurous acid is preferably from 0.15% to 15% by weight.

After the iodine separation step, the activated carbon can be subjected to the gold separation step as described below to recover gold.

Further, in the iodine separation step, an iodine-containing solution containing iodine separated from the activated carbon can be obtained. The iodine-containing solution can be used again as the leaching solution in the leachate step.

### (Gold Separation Step)

In the activated carbon that has undergone the iodine separation step, the iodine has been separated, but gold remains. The activated carbon that has adsorbed the gold can be subjected to the gold separation step to separate the gold from the activated carbon.

The gold separation step can be carried out by various methods, and as an example, the above activated carbon is brought into contact with a cyan solution containing cyan ions added to caustic soda or the like, a solution containing thiosulfate, or other solution to separate the gold adsorbed on the activated carbon.

This can provide activated carbon from which gold has been separated. The activated carbon is subjected to activation or other regeneration processing depending on a decrease in activity or the like, and can be used again in the adsorption step and the like.

### (Copper Separation Step)

The adsorbed solution obtained after adsorbing gold and iodine on the activated carbon in the adsorption step as described above contains copper ions and iron (II) ions. To separate the copper from the adsorbed solution, the copper separation step can be performed.

The separation of the copper from the adsorbed solution may employ a solvent extraction method using an extractant for selectively extracting copper or, rarely, a cementation method.

The copper separated from the adsorbed solution by the solvent extraction or the like can be recovered by electrolysis or the like.

### (Iron Oxidation Step)

The copper-separated solution obtained in the copper separation step contains iron (II) ions. The copper-separated solution can be subjected to an iron oxidation step of processing the copper-separated solution with, for example, iron-oxidizing microorganisms to oxidize the iron (II) ions in the acidic solution to iron (III) ions, such that the copper-separated solution can be reused.

The resulting iron-containing solution can be supplemented with iron (III) ions as needed, and added to the leaching solution used in the leaching step and used again.

### EXAMPLES

The method for processing ores or refining intermediates as described above was experimentally conducted and its effects were confirmed as described below. However, the description herein is merely for the purpose of illustration and is not intended to be limited thereto.

### Test Example 1

Ores containing gold was shaken in a flask with a leaching solution for 24 hours, and a test was conducted to leach gold from the ores. The ores were Kensington ores (a copper purity of 0.85% by mass, a gold purity of 220 ppm by mass), and a solution containing potassium iodide and ferric sulfate was used as the leaching solution. The composition of the leaching solution had a Fe³⁺ ion concentration of 5 g/L and an iodine concentration of 100 mg/L or 1000 mg/L; two types of leaching solutions having different iodine concentrations were prepared. The results are shown in Table 1.

It is understood from the results shown in Table 1 that a relatively high Au leaching rate could be achieved by using both of the leaching solutions having the iodine concentrations of 100 mg/L and 1000 mg/L with shaking for 24 hours. In particular, when the leaching solution having the iodine concentration of 1000 mg/L was used, the Cu leaching rate was 21% and the Au leaching rate was 70.6%, and extremely high Au and Cu leaching rates could be achieved. Even if the leaching solution having the iodine concentration of 100 mg/L was used, the Cu leaching rate was 11% and the Au leaching rate was 7.9%, which were good leaching rates.

TABLE 1

| | | | Leached Solution | | | | |
|---|---|---|---|---|---|---|---|
| | Ore Weight | Amount | KI | Cu | Cu Leaching Rate | Au | |
| | g | mL | mg/L | g/L | % | mg/L | Au Leaching Rate |
| [I—] = 1000 mg/L | 20.13 | 125 | 983.7 | 0.17 | 21 | 25 | 70.6 |
| [I—] = 100 mg/L | 20.16 | 125 | 61.8 | 0.09 | 11 | 2.8 | 7.9 |

### Test Example 2

A leaching solution containing potassium iodide and ferric sulfate was prepared in a flask, and a gold iodide (AuI) reagent was dissolved therein. The resulting solution was brought into contact with activated carbon to adsorb iodine and gold on the activated carbon, and the adsorption rates of iodine and gold were examined by analysis of the solution before and after adsorption.

The adsorbed activated carbon was then removed and impregnated with a sulfurous acid solution to attempt desorption of iodine. The desorption rates of iodine and gold were investigated from analytical values of the desorbed solution after desorption.

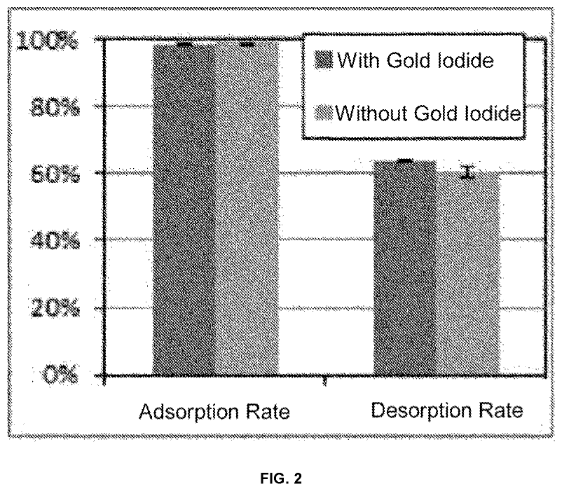

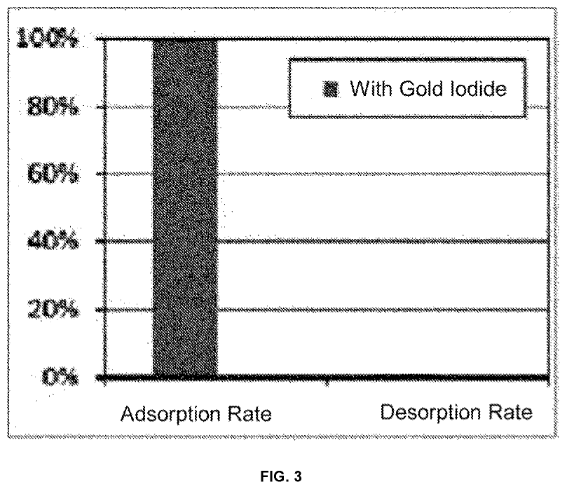

The results are shown in Table 2 and FIGS. 2 and 3.

TABLE 2

| | Solution before Activated Carbon | | | Solution ater Activated Carbon | | | Desorbed Solution | | |
|---|---|---|---|---|---|---|---|---|---|
| | Solution Amount | KI | Au | Solution Amount | KI | Au | Solution Amount | KI | Au |
| | mL | mg/L | mg/L | mL | mg/L | mg/L | mL | mg/L | mg/L |
| With Gold | 166 | 1346 | 32 | 166 | 18 | 0.1 | 277 | 505 | 0.1 |
| Iodide \textcircled{1} | | | | | | | | | |
| With Gold | 165 | 1346 | 35 | 165 | 19 | 0.1 | 278 | 505 | 0.1 |
| Iodide \textcircled{2} | | | | | | | | | |
| Without Gold | 164 | 1561 | | 164 | 18 | | 285 | 525 | |
| Iodide \textcircled{1} | | | | | | | | | |
| Without Gold | 163 | 1743 | | 163 | 18 | | 284 | 617 | |
| Iodide \textcircled{2} | | | | | | | | | |

In this test, “With Gold Iodide” in which gold iodide was dissolved and “Without Gold Iodide” in which gold iodide was not added for comparison were conducted twice for each.

In “With Gold Iodide”, as shown in Table 2, gold was dissolved in the leaching solution at 32 mg/L to 35 mg/L, and when this solution was passed through the activated carbon, the Au concentration was decreased to 0.1 mg/L. This indicates that substantially all of Au was adsorbed on the activated carbon. Further, as can be seen from Table 2 and FIG. 3, the desorbed solution after desorption contained substantially no gold, and most of the gold remained adsorbed on the activated carbon.

As shown in FIG. 2, iodine showed the same behavior regardless of the presence or absence of gold iodide, almost the whole amount of iodine was adsorbed, and about 60% of iodine was desorbed.

Therefore, it was found that the gold leached in the solution was adsorbed on the activated carbon and was not desorbed by sulfurous acid. The above results can indicate that there is no impact on the adsorption and desorption of iodine.

It is found from the above test results that gold can be effectively extracted from the ores gold or refining intermediates that contain gold, by the above method for processing the ores or refining intermediates.

1. A method for processing ores containing gold or refining intermediates containing gold, the refining intermediate being obtained by subjecting the ores to a refining process,
wherein the method comprises: a leaching step of leaching gold from the ores or the refining intermediates using a sulfate solution containing iodide ions and iron (III) ions as a leaching solution; an adsorption step of adsorbing iodine and gold in the leached solution obtained in the leaching step on activated carbon; and an iodine separation step of separating iodine from the activated carbon while leaving gold on the activated carbon that has undergone the adsorption step.

2. The method for processing ores or refining intermediates according to claim 1, wherein iodine is separated using a sulfurous acid solution in the iodine separation step.

3. The method for processing ores or refining intermediates according to claim 1, wherein an iodine concentration in the leaching solution is from 10 mg/L to 10000 mg/L in the leaching step.

4. The method for processing ores or refining intermediates according to claim 1, further comprising a gold separation step of separating gold from the activated carbon from which iodine has been separated in the iodine separation step.

5. The method for processing ores or refining intermediates according to claim 1,
wherein the ores or refining intermediates further contain copper, and gold and copper are leached from the ores or refining intermediates in the leaching step, and
wherein the method further comprises a copper separation step of separating copper from an adsorbed solution obtained in the adsorption step.
